(19) United States
(12) Patent Application Publication
(10) Pub. No.: US 2024/0144301 A1
(43) Pub. Date: May 2, 2024

(54) METHODS AND APPARATUS TO ADAPTIVELY COLLECT MARKET RESEARCH DATA

(71) Applicant: Nielsen Consumer LLC, Chicago, IL (US)

(72) Inventors: Kannan Balaji, Tampa, FL (US); Srikanth R. Tiyyagura, Bangalore (IN); Praveen Kumar Bala, Hyderabad (IN); Brahmanand Reddy Shivampet, Oak Park, CA (US)

(21) Appl. No.: 18/479,594

(22) Filed: Oct. 2, 2023

Related U.S. Application Data
(63) Continuation of application No. 17/345,946, filed on Jun. 11, 2021, now abandoned.

(30) Foreign Application Priority Data
Jun. 12, 2020 (IN) 202011024786

(51) Int. Cl. G06Q 30/0201; G06Q 10/087; G06Q 30/0204; G06Q 40/12

(52) U.S. Cl. CPC G06Q 30/0201; G06Q 10/087; G06Q 30/0205; G06Q 40/12

(57) ABSTRACT

Methods, apparatus, systems and articles of manufacture are disclosed to control auditing devices, comprising a communications interface to transmit first auditing instructions to the auditing devices, a sampling frequency determiner to collect sampling information corresponding to a first number of stores at a first time, a a sample size determiner to calculate a second number of stores to sample based on the sampling information, and when a difference between the first number of stores and the second number of stores satisfies a threshold, improve an accuracy in the sampling information by calculating second auditing instructions having an updated sampling frequency.

### RELATED APPLICATION

This patent arises from an Indian Provisional Patent Application 202011024786 which was filed on Jun. 12, 2020. Indian Provisional Patent Application 202011024786 is hereby incorporated herein by reference in its entirety. Priority to Indian Provisional 202011024786 is hereby claimed.

### FIELD OF THE DISCLOSURE

This disclosure relates generally to the technical field of market research, and, more particularly, to methods and apparatus to adaptively collect market research data.

### BACKGROUND

In recent years, manufacturers desire to know market research data regarding the products. Market research data requires samples collected at particular frequencies.

### BRIEF DESCRIPTION OF THE DRAWINGS

FIG. 1 illustrates an approach to collect market research data.

FIG. 2A and FIG. 2B illustrate an inherent problem in the approach to collect market research described in FIG. 1.

FIG. 3 illustrates an example edge network to collect market research data.

FIG. 4 illustrates layers of the example edge network of FIG. 3 as a system flow diagram.

FIG. 5 is a block diagram of the example edge network of FIG. 3 to adaptively and dynamically collect market research data.

FIG. 6 is an example environment in which teachings disclosed herein may be implemented.

FIG. 7 illustrates an example data flow between the different layers of the edge network of FIGS. 3, 4, 5 and/or 6.

FIG. 8 illustrates an example framework to collect market research data in which collection sampling is dynamically updated for future collection cycles.

FIG. 9 illustrates an example framework to collect market research data in which collection sampling is continuously, and/or dynamically updated within a particular collection cycle.

FIG. 10 is a block diagram of an example implementation of the sample frequency determiner of FIGS. 3, 4, 5, and/or 6 that may be operable on an edge device, in a central office, and/or in the cloud.

FIGS. 11 and 12 are flowcharts representative of example machine readable instructions that may be executed to implement the example sample frequency determiner of FIG. 10.

FIG. 13 is a block diagram of an example processing platform structured to execute the instructions of FIGS. 11-12 to implement the sample frequency determiner of FIG. 10.

FIG. 14 is a block diagram of an example software distribution platform to distribute software (e.g., software corresponding to the example computer readable instructions of FIGS. 11-12) to client devices such as consumers (e.g., for license, sale and/or use), retailers (e.g., for sale, re-sale, license, and/or sub-license), and/or original equipment manufacturers (OEMs) (e.g., for inclusion in products to be distributed to, for example, retailers and/or to direct buy customers).

The figures are not to scale. Unless specifically stated otherwise, descriptors such as “first,” “second,” “third,” etc. are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name. As used herein, “approximately” and “about” refer to dimensions that may not be exact due to manufacturing tolerances and/or other real world imperfections. As used herein “substantially real time” refers to occurrence in a near instantaneous manner recognizing there may be real world delays for computing time, transmission, etc. Thus, unless otherwise specified, “substantially real time” refers to real time +/−1 second.

### DETAILED DESCRIPTION

Consumer packaged goods (CPG) manufacturers want to know their market share, product and pricing position in the market, effectiveness of product, pricing, promotion and distribution, viability of a potential new product, consumer feedback, etc. Such information may be generated by collecting marketing and/or sales data (collectively referred to herein as market research data, sampling information, survey results, etc.) for relevant products from relevant stores in the market. In some examples, the market research data may refer to panelists. As used herein, the market may refer to a particular geographic region (e.g., a particular city, a particular state, a particular country, etc.). Additionally or alternatively, the relevant market may refer to a non-geographic venue through which different stores may compete (e.g., different stores offer goods online through the Internet, which may or may not depend on the geographic proximity of the stores).

To enable adequate data collection in a manner that satisfies statistical confidence, technological tools must be utilized in view of human limitations (e.g., mere pen and paper approaches). In other words, efforts to collect market research data for all products from all stores in the relevant market (e.g., the relevant geographic area) by using human beings (e.g., a fleet of human data collectors) with pen and paper is impractical. Accordingly, example technical solutions are disclosed herein. An audience measurement entity (AME) may collect market research data from a sample of all relevant stores and/or a sample of all relevant products. Based on this collected data, any relevant marketing and/or sales metrics may be extrapolated to the full market through statistical projections.

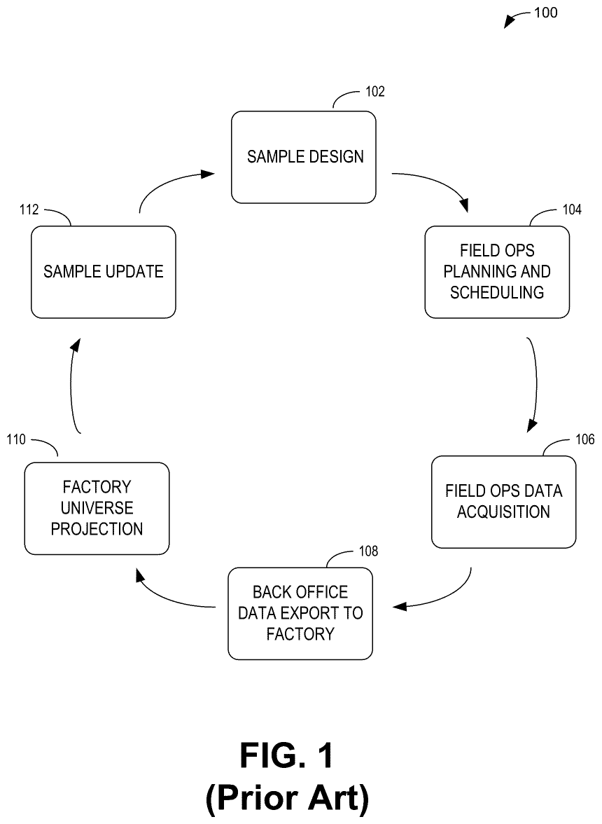

FIG. 1 illustrates a known approach 100 to collect market research data. The known approach 100 includes 6 steps. At block 102, the first step is “Data Science Sample Design.” At block 102, the known approach 100 uses available data and mathematical formulas to determine a number of stores to visit, the number of products to investigate is determined based on available data. At block 104, field operatives are deployed (e.g., data collectors, humans, robotic collectors, IoT devices, etc.) to specific stores. At block 106, stores are surveyed and market research data is acquired. Data is sent to the central office (e.g., digital back office) to which the survey event belongs to. At block 108, the central office (e.g., digital back office) collates, validates, transforms and performs other data cleaning activities and exports the data to a data warehouse (e.g., factory). At block 110, the data warehouse performs advanced statistical processes and derives applicable insights including universe projection (estimating population underlying the original sample selected). At block 112, the data warehouse (also called factory) updates the data science sample based on the factory universe projection (e.g., market research data) and the collected market research data from the field operatives. After block 112, the known approach 100 repeats at block 102. In some examples, the functionality of the example data warehouse is implemented by the example central office or digital back office.

However, the known approach 100 includes limitations. Namely, the samples and/or sample sizes remain static for long periods of time. For example, a sampling event may occur every two, five, or ten years. Within these periods of time, conditions may change such that collected data from the most recent iteration is no longer relevant and/or otherwise representable of current market conditions.

For example, an AME may survey a particular market (e.g., a particular city) to identify all stores selling products of interest for marketing analysis. This initial survey defines the universe of stores within the relevant market. From there, the AME may approach ones of the stores and request their participation in a marketing research study through which the stores may agree to provide relevant market research data and/or to allow data collectors from the AME to visit the store on a periodic basis (e.g., every two weeks, once a month, every two months, etc.) to audit the store and collect relevant market research data. Not all stores may agree to participate in the research study. In some examples, the AME may identify a subset of those stores that do agree to participate in the study as a representative sample of the entire universe of stores identified for the market. Thereafter, the AME may arrange for the collection of market research data from the identified sample of stores and generate marketing and/or sales metrics for relevant products. Reliable metrics depend upon reliable data used to generate results that satisfy statistical expectations. However, as mentioned above, the samples (e.g., stores from which market research data is collected) and/or sample sizes (e.g., the number of stores from which data is collected) can remain static for relatively long periods of time. As such, the data is stale and/or otherwise not representative of current conditions. In other words, stale data is inaccurate, and if used to generate projections, results in inaccurate predictions and/or projections.

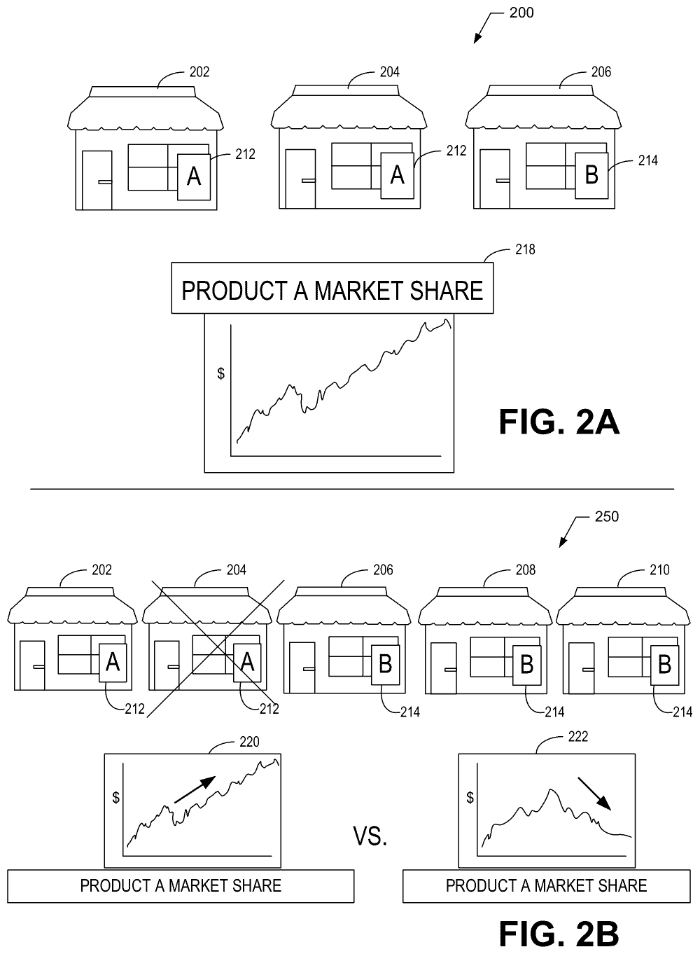

FIG. 2A and FIG. 2B illustrate at least one problem in the known approach 100 to collect market research. In some instances, the particular market may be surveyed only once every two years to update an understanding of the universe of stores in the relevant market. In many places, the universe of stores can change more frequently than every two years as new stores are opened and old stores close.

Therefore, if the universe of stores associated with a particular market has changed significantly since the samples and/or sample sizes were last updated can result in inaccurate metrics because the samples may not be representative of the actual universe and/or the statistical extrapolation of the collected data may be inaccurate.

In FIG. 2A, the environment 200 includes a first store 202, a second store 204, and a third store 206. The example first store 202 and the example second store 204 are carrying a first product 212 (e.g., product A). The example third store 206 is carrying a second product 214 (e.g., product B). In the example of FIG. 2A, the first product 212 has a positively trending market share 218.

In the example of FIG. 2B, the environment 250 includes the first store 202, the second store 204, and the third store 206 of FIG. 2A. The example environment 250 includes a fourth store 208 and a fifth store 210. In the example of FIG. 2B, the environment 250 is the environment 200 after a first time period has elapsed. The second store 204 which carried the first product 212 is now closed. The example fourth store 208 and the example fifth store 210 are new stores that have opened that now carry the second product 214. The market share report 220 for the first product 212 is inaccurate, which depicts the first product 212 with a superior market share. The market share report 222 for the first product 212 is accurate, which depicts the first product 212 as declining in market share.

An increase in the frequency of sampling would generate a more accurate market share report. However, a sampling that includes real-time market share data relating to the product allows for an update in auditing instructions. For example, if the first product 212 is out of stock at a first three stores of a potential ten stores in a first town to be audited, the auditing instructions under the prior solution (e.g., the known approach 100) would be static, and the auditor would continue to audit the other seven stores. However, according to examples disclosed herein, the auditing instructions may be updated in real-time, such that the auditor may visit two stores in three adjacent towns to confirm if the first product is truly out of stock.

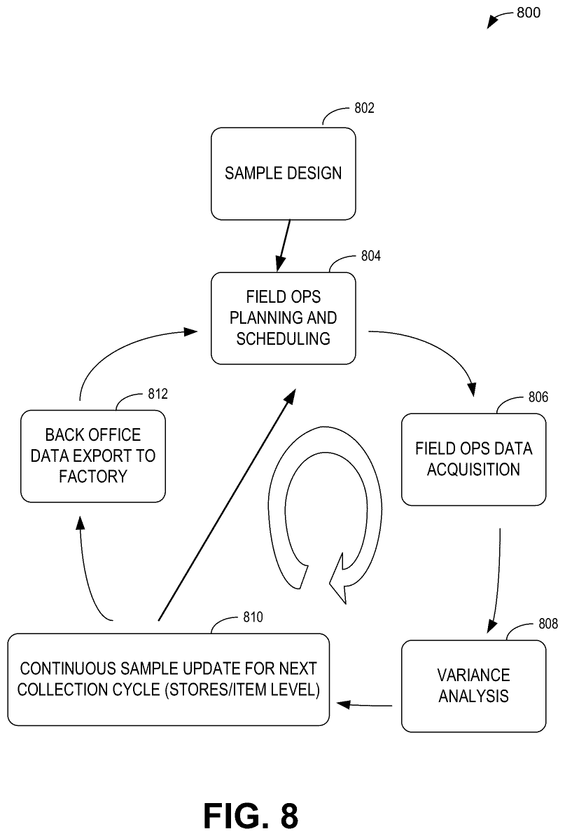

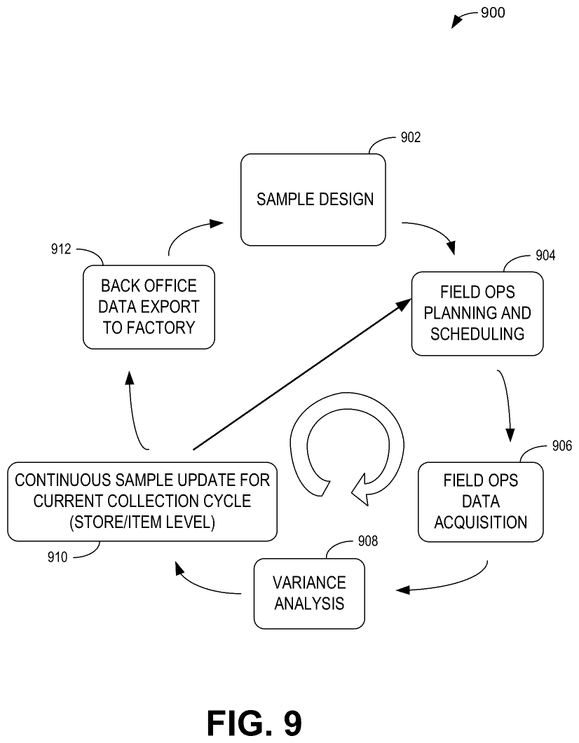

In some examples, during the course of executing the auditing instructions to collect the market research data, the auditor (e.g., data collection robot, human, etc.) may notice and report observe new stores being opened, old stores being closed, and/or existing stores branching into new types of product lines. In some examples, the AME may request and/or incentivize the data collectors in order to update the universe of stores on an ongoing basis. In this manner, the AME may keep on top of changes to the market without having to perform a formal survey of the entire market once every year or two as is done in the past. In some examples, information regarding changes to the universe of stores within a particular market can serve as the basis to dynamically adapt or update the samples and/or sample sizes of the stores from which market research data is collected as illustrated in an example process of FIG. 9, as described in further detail below. In some examples, information regarding new stores openings, old stores closing, adjustments to store offerings, etc. within a particular market may be collected on an ongoing basis but still reevaluate the universe of stores and the associates samples and/or sample sizes used for data collection on a less frequent basis (e.g., every six months, once a year, every two years, etc.). As described in further detail below, an example process of FIG. 8 represents the ongoing collection, but less frequent evaluation of the universe of stores.

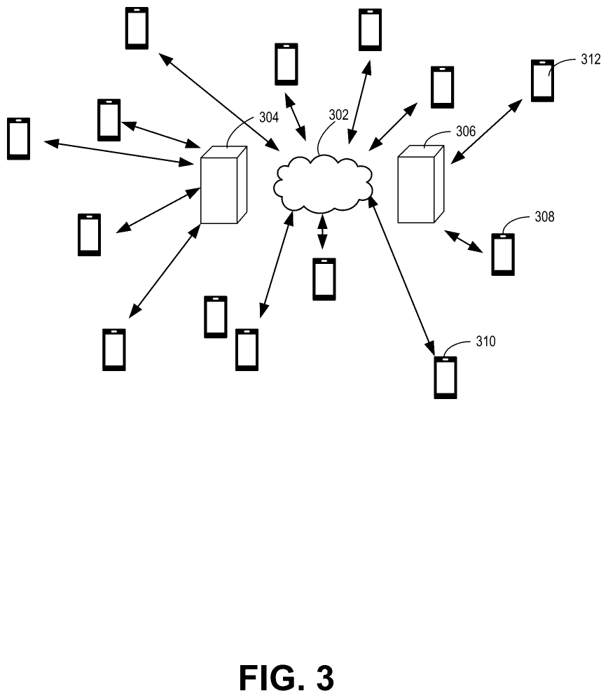

FIG. 3 illustrates an edge network to collect market research data. The edge network is a network topology to facilitate adaptive sample estimation and dynamic data collection. In some examples, the edge network is an edge computing based distributed computing process in which adaptive sample estimation and dynamic data collection can be executed. The illustrated example of FIG. 3 includes a central cloud processor 302, a first data aggregation server 304, a second data aggregation server 306, a first node 308, and a second node 310. The example of FIG. 3 includes multiple nodes that are unlabeled without reference numbers. The example cloud processor 302 may implement a market research entity (e.g., audience measurement entity). In some examples, the example cloud processor 302 may transmit auditing instructions to the nodes of the edge network. In some examples, the nodes of the edge network may be implemented by data collection devices or mobile cellular phones. In some examples, the nodes are to transmit the market research data to the cloud processor 302. The example cloud processor 302 is also called herein a cloud computing server, primary server, the cloud, cloud server.

In some examples, a first plurality of nodes are to transmit first market research data to the first data aggregation server 304, while a second plurality of nodes are to transmit second market research data to the second data aggregation server 306. In some examples, the first data aggregation server 304 corresponds to a first geographic region, and the second data aggregation server 306 corresponds to a second geographic region.

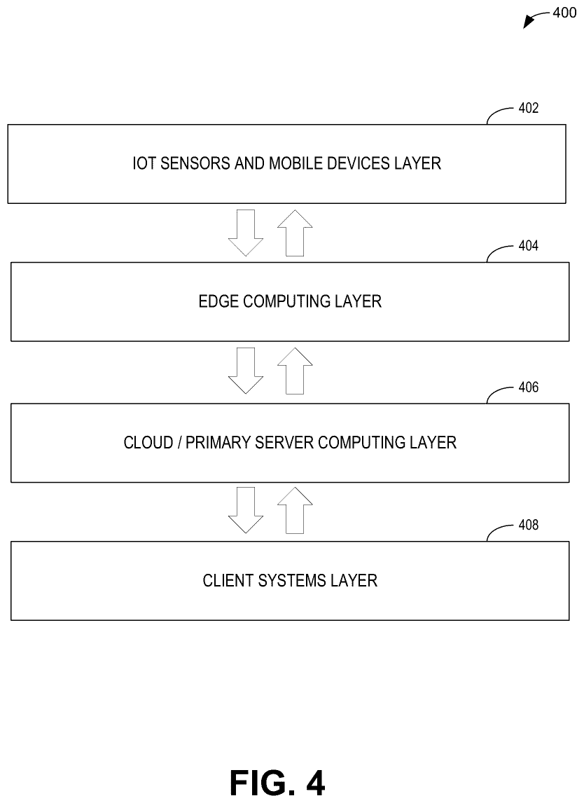

In some instances, an AME may collect market research data from many stores distributed across large geographic areas. In some examples, to reduce bandwidth requirements and/or to increase processor efficiencies, the adaptive sampling and/or dynamic data collection disclosed herein may be implemented using a distributed edge computing system in which different computing devices may be dedicated to particular geographic areas and/or other particular markets to collect the market research data and collect information regarding changes to the universe of stores from which samples are to be identified. In some examples, these separate servers may perform some of the initial analysis to dynamically determine changes to the samples and/or sample sizes without reporting or corresponding directly with a primary server at the back office the AME. This distribution of processing layers from the data collection layer to the edge computing layer, to the primary server layer is represented in FIG. 4.

FIG. 4 illustrates the layers of the edge network of FIG. 3 as a system flow diagram. FIG. 4 includes an example environment 400. The example environment 400 includes example Internet of Things (IoT) sensors and mobile devices layer 402, an example edge computing layer 404, a cloud and/or an example primary server computing layer 406 and an example client systems layer 408. The example IoT sensors and mobile devices layer 402 includes the nodes of FIG. 3. In some examples, the market research data is collected in the IoT sensors and mobile devices layer 402. In some examples, the IoT sensors and mobile devices layer 402 is to update auditing instructions for other nodes in the IoT sensors and mobile devices layer 402.

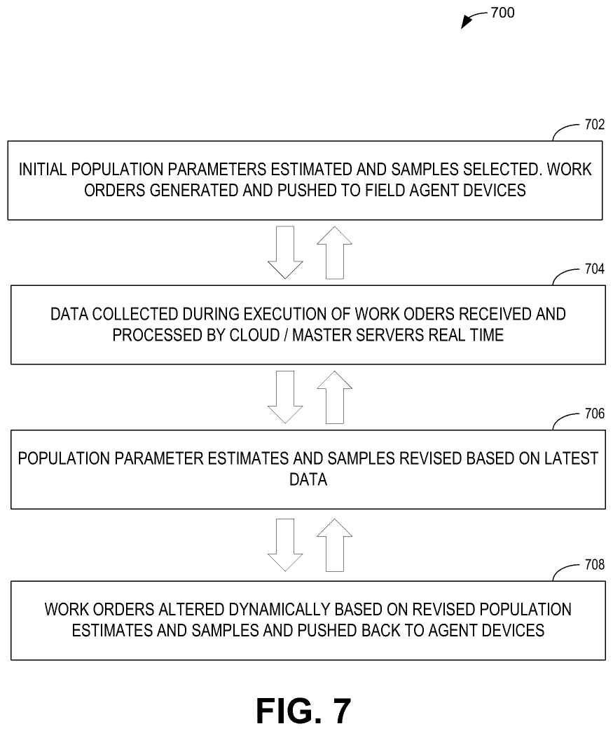

The example edge computing layer 404 may be implemented by the data aggregation servers 304, 306 of FIG. 3. The example edge computing layer is to communicate (e.g., transmit) auditing instructions and/or market research data from the IoT sensors and mobile device layer 402 to the cloud and/or primary server computing layer 406. In some examples, the cloud and/or primary server computing layer 406 is implemented by the cloud processor 302 of FIG. 3. In some examples, the cloud and/or primary server computing layer 406 runs the process of FIGS. 7-8. In some examples, the cloud and/or primary server computing layer 406 is to communicate with the client systems layer 408. In some examples, the client systems layer 408 includes a customer (e.g., client, product manufacturer), and a data warehouse (e.g., factory, data factory). The customer sets acceptable error margins for the market research information. The data warehouse generates factory market research information and applicable insights including universe projection (estimating population underlying the original sample) by performing advanced statistical processes. The factory market research information may be transmitted to the example cloud/primary server computing layer 406 for verification of the market research data obtained by devices in the IoT sensors and mobile devices layer 402. In some examples, the acceptable error margins for the market research information are transmitted to the example cloud/primary server computing layer 406.

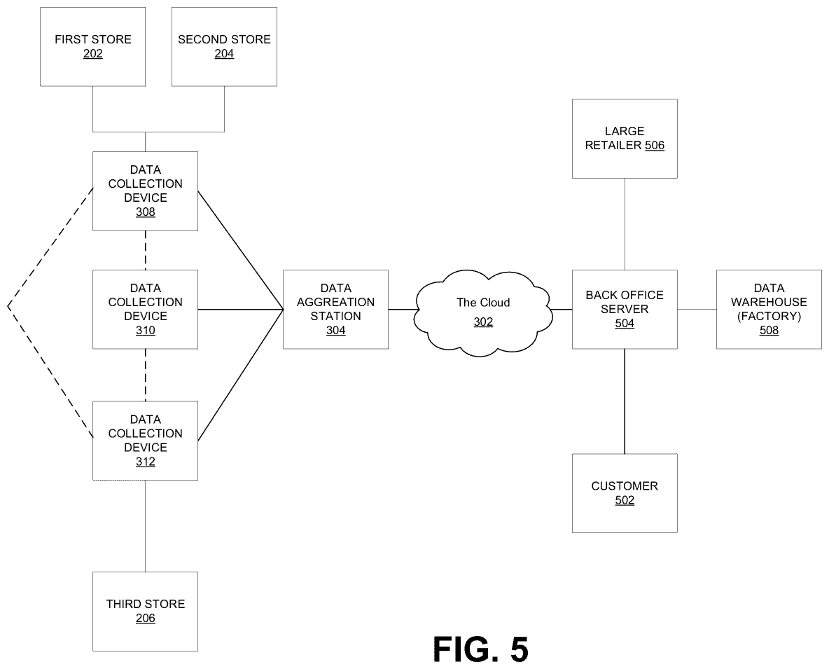

FIG. 5 is a block diagram of the example edge network of FIG. 3 to adaptively and dynamically collect market research data. FIG. 5 includes the example small stores of FIG. 2 (e.g., first store 202, a second store 204, a third store 206), a large retailer 506, a customer 502, a central office 504, a data warehouse 508, the cloud processor 302 of FIG. 3, the example first data aggregation server 304 of FIG. 3, and the example nodes of FIG. 3 (e.g., the example first data collection device 308, the example second data collection 310, and the example third data collection device 312). The example central office 504 may be implemented in the cloud server 302. As used herein, a large retailer 506 may directly report (e.g., transmit, communicate) market research data to the central office 504. As used herein, an auditor visits a small store (e.g., first store 202) to generate market research data. In some examples, the small store is unable to directly report (e.g., electronically transmit, through a digital feed) market research data to the example back office server 504. In some examples, the example first data collection device 308 is to communicate with the example second data collection device 310 as illustrated by the dashed connection lines. In some examples, the data warehouse 508 (e.g., factory) performs advanced statistical processes and derives applicable insights including universe projection (estimating population underlying the original sample selected). In some examples, the example first data collection device 308 is unable to communicate with the example second data collection device 310.

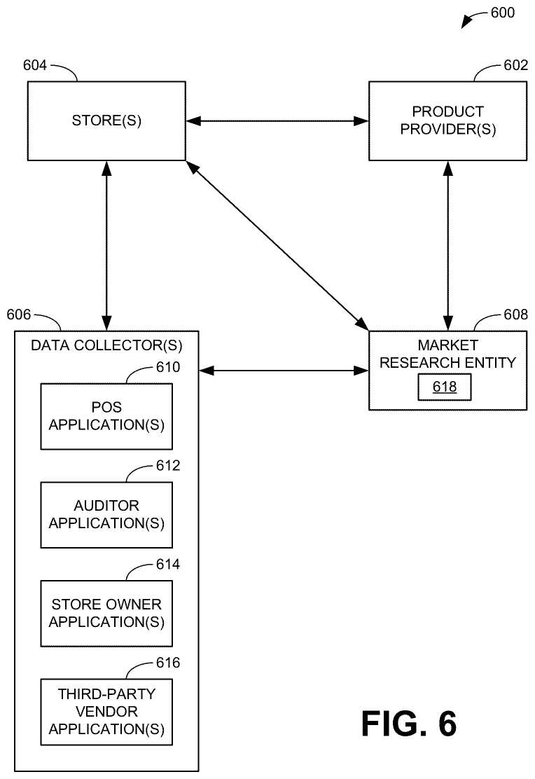

FIG. 6 is an example environment (e.g.., system 600) in which teachings disclosed herein may be implemented. FIG. 6 is a schematic illustration of an example system 600 within which the teachings disclosed herein may be implemented. The example system 600 of FIG. 6 includes one or more product provider(s) 602 (e.g., customer 502 of FIG. 5, manufacturer, factory, etc.) that provide products to one or more store(s) 604 (e.g., first store 202 of FIG. 5, a second store 204 of FIG. 5, a large retailer 506 of FIG. 5 etc.) for sale. As used herein, a product provider is an entity that manufactures, produces, distributes, supplies, and/or otherwise provides products that may be purchased by consumers. As used herein, a store is an entity that is at the consumer-facing end of the product supply chain to interact directly with consumers purchasing products provided by the product providers 602. Although the product provider(s) 602 are shown as distinct entities in the illustrated example, in some instances, a product provider 602 may also be a store 604. In some examples, the store(s) 604 may be brick-and-mortar retail establishments that permit consumers into the premises to view and/or purchase goods. Additionally or alternatively, the store(s) 604 may sell their products via the Internet with their inventories stored at a location that is not open to physical access by consumers.

In the illustrated example of FIG. 6, one or more data collector(s) 606 (e.g., auditors, data collection devices 308 of FIG. 5) may collect marketing and sales data for particular products offered for sale by the store(s) 604 and report their findings to a market research entity 608 (e.g., the central office 504 of FIG. 5, the cloud server 302 of FIG. 5). The one or more data collector(s) 606 may be audit personnel, drones and/or robots. The marketing and sales data may include information indicative of the inventory, stock status, price, sale units (e.g., number of individual items sold as a single unit), units per sale (e.g., number of units purchased at a single time), sale volume (e.g., total number of units sold in a given period), promotional details, and/or any other relevant information about the particular product(s) of interested at a particular point in time (when the data is collected) and/or for a given period of time (a most recent period preceding the collection of the data (e.g., the past week, the past month, etc.)). Data collected by the data collector(s) 606 corresponding to particular product(s) is referred to as collection information. The marketing and sales data may also include information indicative of the nature and/or characteristics of the store 604 from which collection information for particular product(s) is collected. Such data collected about the store(s) 604 is referred to herein as store information. Store information may include the store location (e.g., physical address and/or a broader geographic region (e.g., city, state, and/or country)), the store size (e.g., small, medium, or large), store type, (e.g., grocery store, pharmacy store, clothing store, sporting goods store, big-box store, etc.), and/or any other relevant information about the store 604. In some examples, the store information may be collected and reported to the market research entity 608 by the data collector(s) 606. In some examples, the store information may be collected by the market research entity 608 independent of the data collector(s) 606. For instance, in some examples, the stores 604 (e.g., large retailer 506) may provide the store information directly to the market research entity 608 (e.g., central office 504) as part of an agreement to participate in market research studies conducted by the market research entity 608 (e.g., central office 504).

In some examples, the marketing and sales data may be provided to the market research entity 608 via one or more different data collection channels associated with different types of data collector(s) 606. More particularly, as shown in the illustrated example, a particular data collector 606 may include and/or implement at least one of a Point-of-Sale (POS) application 610, an auditor application 612, a store owner application 614, and/or a third-party vendor application 616.

In some examples, data collectors 606 with POS applications 610 are maintained within a corresponding store 604 at the point-of-sale (e.g., checkout counter). In some examples, data collectors 606 with POS applications 610 are integrated with cash register such that data is collected automatically as products are scanned for purchases at the cash register. In other examples, the data collector 606 may be independent of the cash register.

In some examples, data collectors 606 with auditor applications 612 correspond to portable computing devices (e.g., smartphones, tablets, etc.) that may be carried by an auditor or built into robotic audit devices, drones, mobile camera scanners, etc. that may visit a store 604 to collect desired marketing and sales data (e.g., collection information) associated with particular products of interest. In some examples, a single auditor may visit multiple different stores 604 and collect relevant collection information from each store using the same data collector 606.

In some examples, data collectors 606 with store owner applications 614 correspond to computing devices available to a store owner (or other employee working at the store 604) to gather and report collection information associated with particular products sold at the store 604 and report such information to the market research entity 608. In some examples, such data collectors 606 with store owner applications 614 correspond to portable computing devices (e.g., smartphones, tablets, etc.) that may be carried by personnel within the store 604 similar to the portable computing devices carried by auditors sent by the market research entity 608. Additionally or alternatively, in some examples, data collectors 606 with store owner applications 614 correspond to desktop computers that may be maintained at a fixed location within the store 604 (or at a remote location) with access to marketing and sales data associated with produces sold at the store 604.

In some examples, data collectors 606 with third-party vendor applications 616 correspond to any type of data collector 606 that are managed and/or maintained by entities other than the owner and/or operator of the store 604 and other than the market research entity 608. For example, a particular product provider 602 may perform its own audit of a particular store 604 to gather a marketing and sales data with a corresponding data collector 606 with a third-party vendor application 616 and report the collected information to the market research entity 608. In some examples, third-party vendor applications 616 correspond to e-commerce websites (e.g., AMAZON™).

In some examples, the market research entity 608 performs market research at the request of ones of the product provider(s) 602 and/or the store(s) 604. In some examples, the market research entity 608 corresponds to one of the product provider(s) 602 and/or the store(s) 604. In other examples, as represented in FIG. 6, the market research entity 608 is an independent third-party (e.g., Nielsen Consumer LLC).

In some examples, the data collectors 606 are capable of communicating with the market research entity 608 via a network (e.g., the Internet). In some such examples, the market research entity 608 may transmit auditing instructions to the data collectors 606 identifying what store(s) 604 to visit (e.g., if the data collector 606 is associated with an auditor of the market research entity 608) and/or the particular products for which marketing and sales data is to be collected. In some examples, the data collectors 606 may include sensors to scan barcodes and/or capture pictures of the identified products of interests to facilitate the collection of data. Additionally or alternatively, in some examples, particular individuals (e.g., store managers and/or employees, auditors, etc.) may enter their observations directly onto the data collectors 606 (e.g., via a keyboard and/or touchscreen) as part of the data collection process. In some examples, the data collectors 606 are devices dedicated to the collection of marketing and sales data. In other examples, the data collectors 606 may be multi-function computing device that includes an application to communicate with the market research entity 608.

Regardless of the particular way in which the data is collected or the type of data collector 606 through which the collecting is accomplished, once the data is collected, the data is transmitted to the market research entity 608 (e.g., the central office 504). More particularly, in some examples, data from multiple data collectors 606 (e.g., multiple edge device, multiple nodes, first data collection device 308) are transmitted to a sample frequency determiner 618 of the market research entity 608 to aggregate and process the collected data. In some examples, the sample frequency determiner 618 generates reports based on findings and/or insights obtained from an analysis of the collected data. In some examples, such reports may be provided to the product provider(s) 602 and/or the store(s) 604. In some examples, sample frequency determiner 618 also collects and analyzes data indicating changes a relevant market, either at the store level or the product level. In some such examples, the sample frequency determiner 618 may dynamically adjust and/or adapt the particular stores used for data collect and/or the particular products within such stores for which market research data is collected based on the changes indicated in the market so as to maintain the collected data as representative as possible to the entire universe of the market. Dynamically adapting data collection in this manner provides for improvements in the accuracy of the resulting market research metrics. Furthermore, dynamically adapting data collection in this manner can also reduce operating costs by specifying an appropriate amount of data collection (e.g., appropriate sample sizes) that produce the reliable metrics without spending more time and expense on unnecessary data collection.

FIG. 7 illustrates an example data flow 700 between the different layers of the edge network of FIGS. 3, 4, 5 and/or 6. At block 702, the central office 504 of FIG. 5 (e.g., market research entity 608 of FIG. 6, AME, etc.) estimates initial population parameters and determines the products to sample. The central office 504 may generate work orders (e.g., auditing instructions) and push (e.g., transmit, communicate) the work orders to field agent devices (e.g., edge devices, nodes, first data collection device 308). At block 704, the data collection devices (e.g., nodes, field agent devices) collect market research data and transmits the market research data to the example cloud server 302 of FIG. 3 and/or the primary server 302 of FIG. 3 in real time. At block 706, the cloud computing server 302 of FIG. 3 may revise population parameter estimates and samples based on latest market research data. At block 708, the cloud computing server 302 of FIG. 3 may dynamically alter the work orders (e.g., auditing instructions) based on the revised population parameter estimates and samples. The example cloud computing server 302 may push (e.g., transmit, communicate) the updated work orders (e.g., auditing instructions) back to field agent devices (e.g., nodes, data collection devices, drones, robotic data collectors, etc.).

FIG. 8 illustrates an example framework 800 to collect market research data in which collection sampling is dynamically updated for future collection cycles. The example framework 800 begins at block 802.

At block 802 (“Sample Design”), samples are designed (e.g., by research personnel, by machine learning algorithms, etc.). As used herein, a sample is a prediction based on initial population parameters. The operation of block 802 may occur at any frequency such as once a year (e.g., an extended time period may pass). In other examples, the operation of block 802 may occur once every five years. In some examples, the sample data determines estimates of universe distribution. As used herein, distribution refers to any type of statistical distribution such as a normal distribution, a Poisson distribution, etc. Example statistical distributions are described by parameters such as mean, variance, etc. Sample data can be used to determine these for population distribution parameters.

At block 804 (“Field Ops Planning and Scheduling”), field agent (e.g., field operative, auditor, data collection device) operations are planned and scheduled (e.g., by research personnel, by machine learning algorithms, etc.). For example, the central office 504 may generate the auditing instructions and transmit the auditing instructions to the data collection devices. Block 804 (“Field agent operation planning and Scheduling”) may occur at any frequency, but typically occurs in a shorter time frame than block 802 (“Sample Design”). Some typical windows of time include a month for executing Block 804.

At block 806 (“Field Ops Data Acquisition”), the data collection devices acquire data. In some examples, block 806 (“Field Ops Data Acquisition”) may occur at any frequency, but typically occurs in a shorter time frame than both block 802 (“Sample Design”) and block 804 (“Field agent operation planning and Scheduling”). For example, the example data collection devices may collect data from stores and to report the market research data (information) is substantially real-time and/or hourly updates. The data collection devices are used such that stores are surveyed and market research data is acquired. The market research data (the sampling information) is sent to the central office (e.g., digital back office, the example back office server 504) to which the survey event belongs to.

At block 808 (“Variance Analysis”), the edge network performs variance analysis on the market research data. In some examples, the edge devices perform the variance analysis on the market research data. In some examples, the cloud computing server performs the variance analysis on the market research data. For example, depending on a threshold (e.g., target) amount of variance for a specific product, the cloud computing server may alter the work order (e.g., auditing instructions) for nodes in the same geographic region.

At block 810 (“Continuous Sample Update for Next Collection Cycle”), the cloud computing server may continuously update the sample for current collection cycle. In some examples, a current collection is a specific number of stores or an item level. At block 810, the sample is updated in real time and transferred to block 812 and block 804.

At block 812 (“Back Office Data Export to Factory”), the back office may export the data to the data warehouse (e.g., factory). The insights gleaned from the first collection cycle are used in the next collection cycle, as the process continues from block 812 back to 804. In addition, the insights gleaned from the first collection cycle are used in the current collection cycle, as the process is able to continue from block 810 to block 804. For example, a collection cycle may be a week of sampling, and based on the market research data obtained on Monday, the auditing instructions may be changed for Tuesday based on the variance of the products collected.

FIG. 9 illustrates an example framework 900 to collect market research data in which collection sampling is automatically, continuously, and/or dynamically updated within a particular collection cycle. FIG. 9 begins at block 902 where sample design occurs.

At block 902 (“Sample Design”), samples are designed (e.g., by research personnel, by machine learning algorithms, etc.). As used herein, a sample is a prediction based on initial population parameters. The operation of block 902 may occur at any frequency such as once a year (e.g., an extended time period may pass). In other examples, the operation of block 902 may occur once every five years. In some examples, the sample data determines estimates of universe distribution.

At block 904 (“Field Ops Planning and Scheduling”), field agent (e.g., field operative, auditor, data collection device) operations are planned and scheduled (e.g., by research personnel, by machine learning algorithms, etc.). For example, the central office 504 may generate the auditing instructions and transmit the auditing instructions to the data collection devices. Block 904 (“Field agent operation planning and Scheduling”) may occur at any frequency, but typically occurs in a shorter time frame than block 902 (“Sample Design”). Some typical windows of time include a month for executing block 904.

At block 906 (“Field Ops Data Acquisition”), the data collection devices acquire data. In some examples, block 906 (“Field Ops Data Acquisition”) may occur at any frequency, but typically occurs in a shorter time frame than both block 902 (“Sample Design”) and block 904 (“Field agent operation planning and Scheduling”). For example, the data collection devices may collect data from stores and to report the market research data (information) is substantially real-time and/or hourly updates. The data collection devices are used such that stores are surveyed and market research data is acquired. The market research data (the sampling information) is sent to the central office (e.g., digital back office, the example back office server 504) to which the survey event belongs to.

At block 908 (“Variance Analysis”), the edge network performs variance analysis on the market research data. In some examples, the edge devices perform the variance analysis on the market research data. In some examples, the cloud computing server performs the variance analysis on the market research data. For example, depending on a threshold (e.g., target) amount of variance for a specific product, the cloud computing server may alter the work order (e.g., auditing instructions) for nodes in the same geographic region.

At block 910 (“Continuous Sample Update for Next Collection Cycle”), the cloud computing server may continuously update the sample for current collection cycle. In some examples, a current collection is a specific number of stores or an item level. At block 910, the sample is updated in real time and transferred to block 912 and block 904.

At block 912 (“Back Office Data Export to Factory”), the back office may export the data to the data warehouse (e.g., factory). The insights gleaned from the first collection cycle are used in the next collection cycle, as the process continues from block 912 back to block 902. The insights from the data warehouse are incorporated in the sample design. In addition, the insights gleaned from the first collection cycle are used in the current collection cycle, as the process is able to continue from block 910 to block 904. For example, a collection cycle may be a week of sampling, and based on the market research data obtained on Monday, the auditing instructions may be changed for Tuesday based on the variance of the products collected.

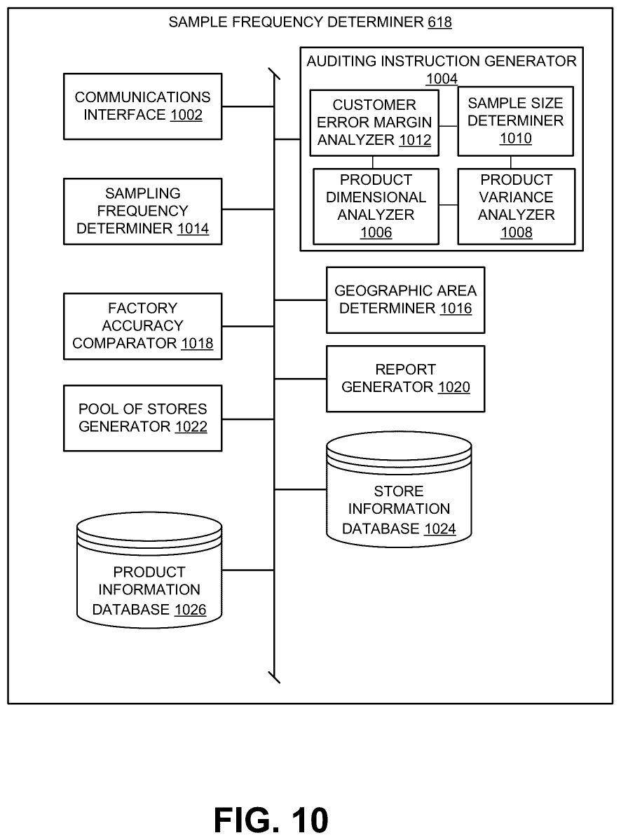

FIG. 10 is a block diagram of an example implementation of the sample frequency determiner 618 of FIGS. 3, 4, 5, and/or 6 that may be operable on an edge device, in a central office, or in the cloud. The example sample frequency determiner 618 includes a communications interface 1002, an auditing instruction generator 1004, a product dimensional analyzer 1006, a product variance analyzer 1008, a sample size determiner 1010, a customer error margin analyzer 1012, a sampling frequency determiner 1014, a geographic area determiner 1016, a factory accuracy comparator 1018, a report generator 1020, a pool of stores generator 1022, a store information database 1024, and a product information database 1026. In some examples, the example auditing instruction generator 1004 includes the example product dimensional analyzer 1006, the example product variance analyzer 1008, the example sample size determiner 1010, and the example customer error margin analyzer 1012.

In operation, the example communications interface 1002 communicates (e.g., electronically transmit, electronically receive through a network such as the Internet, one or more edge networks) market research information, auditing instructions, and/or customer error margin data. For example, if the sample frequency determiner 618 is operable on the primary server in the cloud 302 of FIG. 3, the example communications interface 1002 communicates with data aggregation server 304 of FIG. 3, the example customer 502, and the example large retailer 506. For example, if the sample frequency determiner 618 is operable on a node of the edge network (e.g., a first data collection device 308 of FIG. 3), the communications interface 1002 is to communicate with other nodes of the edge network (e.g., a second data collection device 310 of FIG. 3) and/or the data aggregation server (e.g., a first geographic data aggregation server 304 of FIG. 3). In some examples, the example communications interface 1002 routes the data received to the example product information database 1026 or to the example auditing instruction generator 1004.

The example auditing instruction generator 1004 generates the auditing instructions (e.g., work orders, sampling instructions etc.) by utilizing data received with the example product dimensional analyzer 1006, the example product variance analyzer 1008, the example sample size determiner 1010, and the example customer error margin analyzer 1012. The example auditing instruction generator 1004 utilizes a sample size formula which determines the number of stores to sample based on the different product dimensions, the variance of the different product dimensions, and the customer target error margin. An example sample size formula is listed below as Equation 1:

$$n = {Z}^{2} * \frac{{σ}^{2}}{{e}^{2}} \qquad Equation 1$$

In the illustrated example of Equation 1, n is the required sample size, Z is the Z value at the required confidence level of the underlying population distribution, σ (sigma) is the estimated standard deviation of the underlying population, and e is the acceptable error margin.

The example sample size formula of Equation 1 accounts for multiple dimensions and may be used with chaotic and delayed data once in a few months or years. The example sample size formula illustrates that a change to either the Z value of the underlying population distribution or the estimated standard deviation of the underlying population alters the needed sample size to maintain the acceptable error margin.

In some examples, a slight change to either the Z value of the underlying population distribution or the estimated standard deviation of the underlying population may drastically alter the needed sample size by an increased (e.g., larger) amount to maintain the acceptable error margin. For example, if the Z value of the underlying population distribution and the acceptable error margin were held constant and the estimated standard deviation of the underlying population was 10, resulting in a sample size of 100, an increase of the estimated standard deviation of the underlying population to 12 results in a sample size of 144. In the illustrated example, the slight increase of 2 in the estimated standard deviation of the underlying population led to a large change in the required sample size.

The example product dimensional analyzer 1006 is to determine the dimensions of the product to analyze. For example, the example product dimensional analyzer 1006 may determine a first three dimensions (e.g., price, location, brand) are to be analyzed, while a second three dimensions (e.g., product, display, category) will not be included in the calculation or the auditing instructions. As used herein, dimensions may include product, price, sales, packing, display, promotion, category, store, geographic location and manufacturer. In some examples, dimensions that correspond to panelists include least one of age, geography, ethnicity, income levels, education, and gender.

The example product variance analyzer 1008 is to analyze the product variance data included in the market research information. For example, for a first product such as a loaf of bread, the average price may be four dollars, while at some stores the price for the loaf of bread may be six dollars or two dollars. For some products, there exists a degree of variance (a spread between the values of a specific dimension) that exceeds a target threshold, wherein the higher the degree of variance, the higher the sample size of the stores. In some examples, the example product variance analyzer 1008 is to use a threshold to determine to account for the variance. The example product variance analyzer 1008 is to receive the market research information from the example communications interface 1002 which is received from the example nodes of the edge network in substantially real time. The constant stream of variance data is used to update the sample size which is expressed in the auditing instructions which are sent back to the example nodes of the edge network.

The example sample size determiner 1010 is to determine the sample size to include in the auditing instructions. In some examples, the sample size is for a number of stores to sample. In some examples, the sample size is for a number of products to sample. For example, based on the customer error margin, and the variance, the sample size determiner 1010 may determine to increase the sample size to achieve the target error margin (e.g., accuracy) or to decrease the sample size to save costs.

The example customer error margin analyzer 1012 is to incorporate the desired, target error threshold specified by the customer. For example, a first customer may desire to know the market research data from a first product to an accuracy (e.g., confidence interval) of 95%. In other examples, a second customer may desire to save costs and desire to know the market research data to an error margin of 90%.

The example product dimensional analyzer 1006, the example product variance analyzer 1008, the example sample size determiner 1010, and the example customer error margin analyzer 1012 operate to generate the auditing instructions which are transmitted via the communications interface 1002 to the data collection devices.

The example sampling frequency determiner 1014 determines the frequency of store visits in the auditing instructions. For example, a first data collection device 308 may receive auditing instructions to sample three stores for a first month, and three more stores for the second month. The example sampling frequency determiner 1014 may update the auditing instructions such that the example first data collection device 308 is to visit three stores for a first week, and three more stores for the second week.

The example geographic area determiner 1016 is to determine the geographic range for the update to the sample size in the auditing instructions. For example, a first geographic region may include one thousand data collection devices while a second geographic region may include one thousand different data collection devices. The first geographic region may be thousands of miles apart from the second geographic region, such that the dimensional data and the product variance data for the first geographic region does not impact the dimensional data and the product variance data for the second geographic region. Similarly, in some examples, the sample size of the first geographic region may not be correlated (e.g., impacted by) the sample size of the second geographic region. The example geographic area determiner 1016 is a feature of the data aggregation servers (e.g., a first data aggregation server 304 of FIG. 3).

The example factory accuracy comparator 1018 is to compare the factory market research data generated by the data warehouse (e.g., factory) to the market research data generated by the report generator 1020. For example, a market research report may be generated by the example report generator 1020 and transmitted to an example data warehouse (e.g., factory). The example data warehouse is to generate an internal market research report based on advanced statistical formulas and transmit the report to the example sample frequency determiner 618. The example factory accuracy comparator 1018 is to use the data of the factory market research report in the calculations to determine the accuracy and/or consistency of the market research generated by the example report generator 1020.

The example report generator 1020 is to generate market research reports based on the market research information. For example, the example market research report 218 of FIG. 2 may be generated by the example report generator 1020, and then transmitted by the example communications interface 1002. The example market research reports include estimates of market share, product price, and other factors.

The example pool of stores generator 1022 is to determine a universe of stores in a relevant market. The example pool of stores generator 1022 is to also determine a pool of stores within the universe of stores from which market research data may be collected. For example, a certain number of stores in the universe of stores may be unavailable or decline to be audited.

The example store information database 1024 is a database that is configured to store (e.g., save, archive) store information. In some examples, store information may include the location of the store, the products included in the store, the opening date of the store, the closing date of the store. The example store information is used by the example auditing instruction generator 1004.

The example product information database 1026 is a database that is configured to store (e.g., save, archive) product information. For example, the values of the dimensions for a specific product such as price, brand, packaging, etc. may be stored in the example product information database 1026. The product variance may also be stored in the example product information database 1026.

While an example manner of implementing the sample frequency determiner 618 of FIGS. 3, 4, 5, and/or 6 is illustrated in FIG. 10, one or more of the elements, processes and/or devices illustrated in FIG. 10 may be combined, divided, re-arranged, omitted, eliminated and/or implemented in any other way. Further, the example communications interface 1002, the example auditing instruction generator 1004, the example product dimensional analyzer 1006, the example product variance analyzer 1008, the example sample size determiner 1010, the example customer error margin analyzer 1012, the example sampling frequency determiner 1014, the example geographic area determiner 1016, the example factory accuracy comparator 1018, the example report generator 1020, the example pool of stores generator 1022, the example store information database 1024, the example product information database 1026 and/or, more generally, the example sample frequency determiner 618 of FIG. 6 may be implemented by hardware, software, firmware and/or any combination of hardware, software and/or firmware. Thus, for example, any of the example communications interface 1002, the example auditing instruction generator 1004, the example product dimensional analyzer 1006, the example product variance analyzer 1008, the example sample size determiner 1010, the example customer error margin analyzer 1012, the example sampling frequency determiner 1014, the example geographic area determiner 1016, the example factory accuracy comparator 1018, the example report generator 1020, the example pool of stores generator 1022, the example store information database 1024, the example product information database 1026 and/or, more generally, the example sample frequency determiner 618 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example communications interface 1002, the example auditing instruction generator 1004, the example product dimensional analyzer 1006, the example product variance analyzer 1008, the example sample size determiner 1010, the example customer error margin analyzer 1012, the example sampling frequency determiner 1014, the example geographic area determiner 1016, the example factory accuracy comparator 1018, the example report generator 1020, the example pool of stores generator 1022, the example store information database 1024, the example product information database 1026 is/are hereby expressly defined to include a non-transitory computer readable storage device or storage disk such as a memory, a digital versatile disk (DVD), a compact disk (CD), a Blu-ray disk, etc. including the software and/or firmware. Further still, the example sample frequency determiner 618 of FIG. 6 may include one or more elements, processes and/or devices in addition to, or instead of, those illustrated in FIG. 10, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

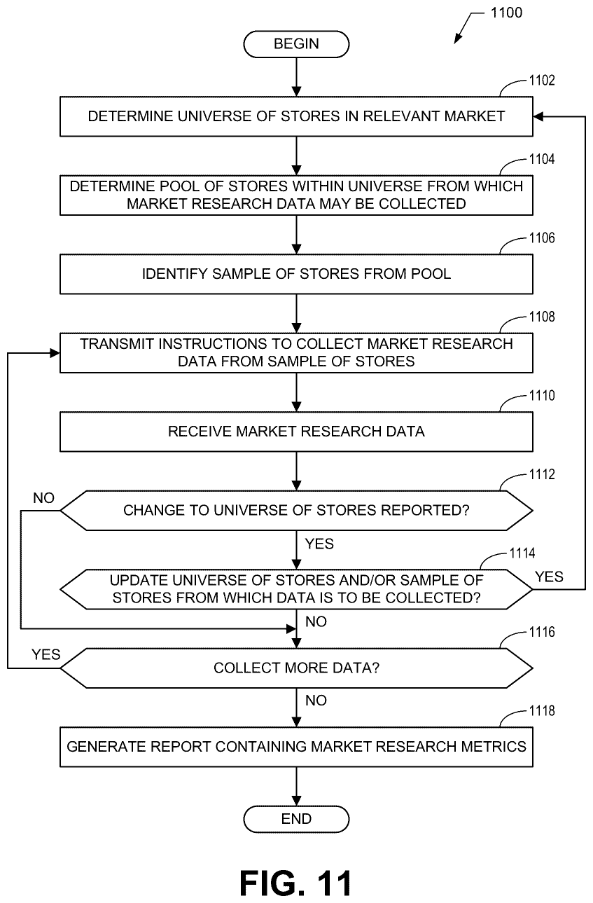

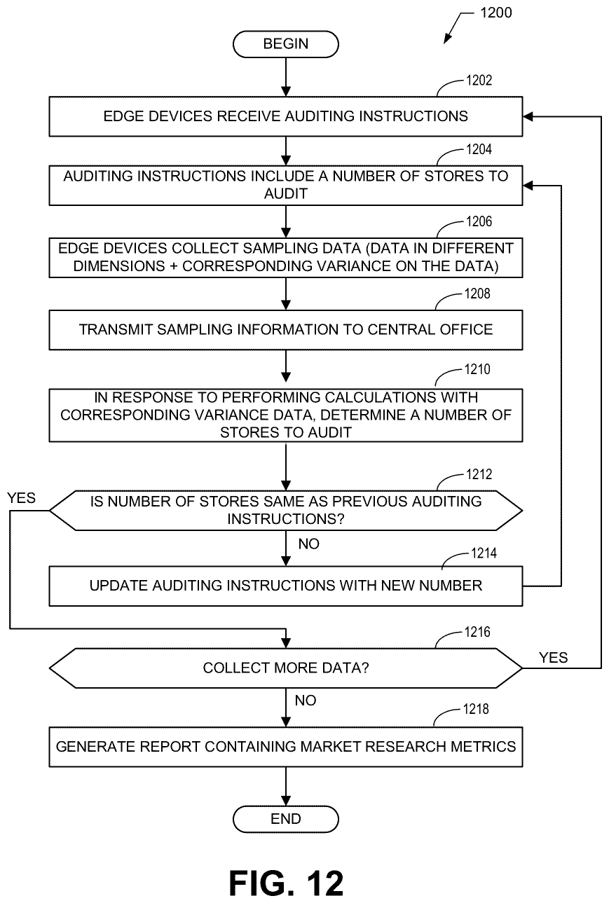

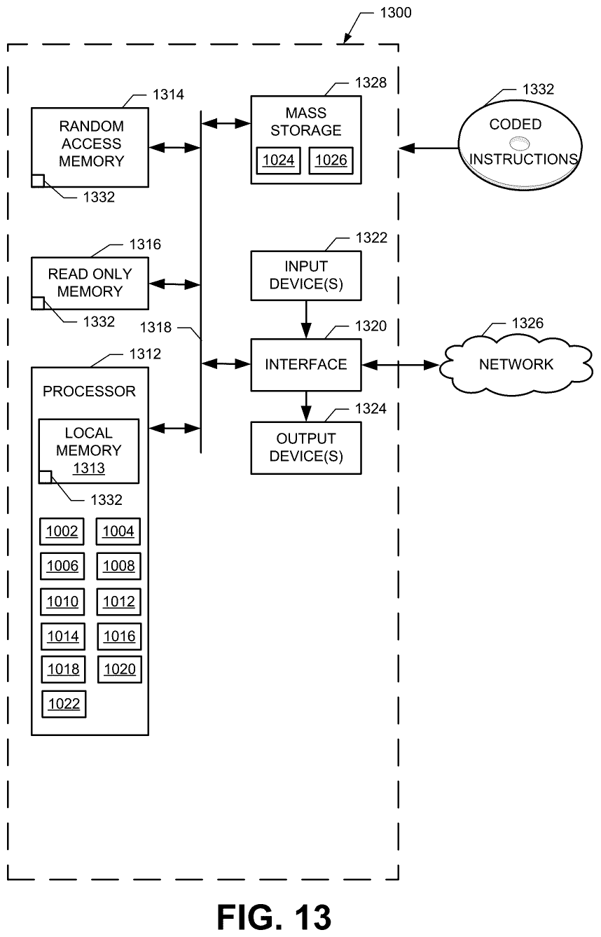

Flowcharts representative of example hardware logic, machine readable instructions, hardware implemented state machines, and/or any combination thereof for implementing the sample frequency determiner 618 of FIG. 10 are shown in FIGS. 11-12. The machine readable instructions may be one or more executable programs or portion(s) of an executable program for execution by a computer processor and/or processor circuitry, such as the processor 1312 shown in the example processor platform 1300 discussed below in connection with FIG. 13. The program may be embodied in software stored on a non-transitory computer readable storage medium such as a CD-ROM, a floppy disk, a hard drive, a DVD, a Blu-ray disk, or a memory associated with the processor 1312, but the entire program and/or parts thereof could alternatively be executed by a device other than the processor 1312 and/or embodied in firmware or dedicated hardware. Further, although the example program is described with reference to the flowchart illustrated in FIGS. 11-12, many other methods of implementing the example sample frequency determiner 618 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more devices (e.g., a multi-core processor in a single machine, multiple processors distributed across a server rack, etc).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement one or more functions that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc. in order to execute the instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example processes of FIGS. 11-12 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

FIG. 11 is a flowchart representative of machine readable instructions 1100 that may be executed to implement the example sample frequency determiner 618 to adaptively sample based on received data. The example pool of stores generator 1022 determines a universe of stores in relevant market (block 1102). For example, the example pool of stores generator 1022 may determine the universe of stores and the statistical distribution parameters of the variables required, in a relevant market by determining a first plurality of stores does not affect the relevant market and excluding the first plurality of stores from the universe of stores. The example pool of stores generator 1022 may determine the statistical distribution (e.g., normal distribution, Poisson distribution, etc.) parameters such as mean, variance, etc. Sample data can be used to determine these for population distribution parameters. Control flows to block 1104.

At block 1104, the example pool of stores generator 1022 determines a pool of stores within universe from which market research data may be collected (block 1104). For example, the example pool of stores generator 1022 may determine a pool of stores from within the universe of stores from which market research data may be collected by requesting that a first store allow data collection devices (e.g., auditing devices) to collect market research data. Control flows to block 1106.

At block 1106, the example auditing instruction generator 1004 identifies a sample of stores from the pool of stores (block 1106). For example, the example auditing instruction generator 1004 may identify a sample of stores from the pool of stores by determining that a first plurality of stores in a first region are to be sampled based on a characteristic the stores in the first plurality of stores share. The technical field of market research includes an amount of stores, shoppers, employees, products and product variations that render human efforts impractical while attempting to process such volumes of data. As such, examples disclosed herein employ specific and/or generic computing devices to perform one or more task/objectives. In circumstances, where generic computing devices are used, such computing devices are specifically and uniquely structured to accomplish examples disclosed herein. Even with the aid of technological resources, volumes of data are managed such that only certain stores are sampled, as a representative of the other stores.

At block 1108, the example communications interface 1002 transmits instructions to collect market research data from sample of stores. For example, the example communications interface 1002 may transmit auditing instructions to collect market research data from the sample of stores by pushing the auditing instructions to the edge devices (e.g., data collection devices).

At block 1110, the example communications interface 1002 receives market research data. For example, the example communications interface 1002 may receive market research data by receiving the product dimensional data and the product variance data from the edge devices (e.g., data collection devices).

At block 1112, the example sampling frequency determiner 1014 determines if a change to the universe of stores is reported. For example, the example sampling frequency determiner 1014 may determine if a change to the universe of stores is reported by receiving the market research information from the example data collection devices. If there is a change in the universe of stores reported by the example data collection devices (e.g., “YES”), control flows to block 1114. If there is not a change in the universe of stores reported by the example data collection devices (e.g., “NO”), control flows to block 1116.

At block 1114, in response to receiving a change in the universe of stores, the example replacement data request generator 1028 determines to update the universe of stores and/or the sample of stores from which data is to be collected. If the example replacement data request generator 1028 determines to update the universe of stores and/or the sample of stores from which data is to be collected (e.g., “YES”), control flows to block 1102, where the example pool of stores generator 1022 is to determine the universe of stores in the relevant market based on the updated store information. If the example replacement data request generator 1028 determines not to update the universe of stores and/or the sample of stores from which data is to be collected (e.g., “NO”), control flows to block 1116.

At block 1116, the example sample frequency determiner 618 determines whether to collect more data. If the example sample frequency determiner 618 determines to collect more data, (e.g., “YES”), control flows to block 1108, wherein the example communications interface 1002 transmits auditing instructions to collect market research data. If the example sample frequency determiner 618 determines not to collect more data, (e.g., “NO”), control flows to block 1118.

At block 1118, the example report generator 1020 generates a report containing market research metrics. For example, the example report generator 1020 may generate a report containing market research data, product placement, variance, and/or other information. The example instructions 1100 end.

The example sample frequency determiner 618 is able to determine whether to add stores to the pool of stores for sampling based on the market research data. Determining whether to add stores to the universe and still achieve a target threshold of data accuracy allows for less wasted internet bandwidth and less wasted auditing (e.g., survey) time. When the example sample frequency determiner 618 determines to add stores to the universe, the universe size estimates increase. The example sample frequency determiner 618 may send an instruction to the data collection device to recruit (e.g., request) the additional stores to join the pool of stores. The example sample frequency determiner 618 is able to determine sampling frequency of products based on the market research data received as described in FIG. 12.

FIG. 12 is a flowchart representative of machine readable instructions 1200 that may be executed to implement the example sample frequency determiner 618 to adaptively determine the sample size based on the product dimension data and the product variance data.

At block 1202, the auditing instruction generator 1004 generates auditing instructions, which are received by the edge devices. For example, the auditing instruction generator 1004 may generate auditing instructions which are transmitted to the edge devices by the example communications interface 1002 by utilizing the example product dimensional analyzer 1006, the example product variance analyzer 1008, the example sample size determiner 1010, and the example customer error margin analyzer 1012.

At block 1204, the example sample size determiner 1010 determines a number of stores to audit, the number of stores to audit included in the auditing instructions. For example, the example sample size determiner 1010 may determine a number of stores to audit by using a mathematical formula which uses the product dimension data and the product variance data.

At block 1206, the example data collection devices collect sampling data (data in different dimensions and corresponding variance data). For example, the example data collection devices (e.g., the first data collection device 308 of FIG. 3, the edge devices, the nodes of the edge network) may sample market research data, the market research data including product dimension data and product variance data.

At block 1208, the example data collection devices transmit the sampling information to the central office. For example, the example data collection devices (e.g., edge devices, a first edge device 308) may transmit market research data to the communications interface 1002 of the example sample frequency determiner 618. In some examples, the example data collection devices may transmit the market research data to a data aggregation server.

At block 1210, the example product dimensional analyzer 1006 and the example product variance analyzer 1008 perform calculations with the corresponding product variance data, the example sample size determiner 1010 determines a number of stores to audit. For example, the example product dimensional analyzer 1006 and the example product variance analyzer 1008 may perform calculation with the corresponding product variance data by using a formula (e.g., Equation 1 above). For example, the example sample size determiner 1010 may determine a number of stores to audit based on the example product variance data and the product dimensional data.

At block 1212, the example auditing instruction generator 1004 determines if the currently calculated number of stores to audit is the same as the previously calculated number of stores to audit, which was included in the first example auditing instructions. In response to the number of stores being the same (e.g., “YES”), control flows to block 1216. In response to the number of stores being not the same (e.g., “NO”), control flows to block 1214.

The example auditing instruction generator 1004 may determine that the increase or decrease in the number of stores exceeds a threshold. For example, if the previous number of stores to sample was one thousand, and based on the updated product dimension data and the updated product variance data, the example sample size determiner 1010 may determine to sample two thousand stores. The increased number of stores to sample (two thousand) may exceed, for example, a twenty percent threshold, wherein control flows to block 1214. In some examples, the increase or the decrease in stores to sample does not exceed a threshold. For example, if the first number of stores is one thousand, and the updated number of stores is one thousand and two stores, the example sample size determiner 1010 may round the updated number and control flows to block 1216.

At block 1214, the example auditing instruction generator updates the auditing instructions with the second (new) number of stores to audit. Control flows to block 1204, wherein the sample size determiner 1010 updates the auditing instructions.

At block 1216, the auditing instruction generator determines whether to collect more data. In response to a determination to collect more data (e.g., “YES”), control flows to block 1202, wherein the edge devices receive updated auditing instructions. In response to a determination to not collect more data (e.g., “NO”), control flows to block 1218.

At block 1218, the example report generator 1020 generates a report containing market research data. For example, the example report generator 1020 may generate a report containing market research data, product placement, variance, and/or other information. The example instructions 1200 end.

FIG. 13 is a block diagram of an example processor platform 1300 structured to execute the instructions of FIGS. 11-12 to implement the sample frequency determiner 618 of FIG. 10. The processor platform 1300 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset or other wearable device, or any other type of computing device.

The processor platform 1300 of the illustrated example includes a processor 1312. The processor 1312 of the illustrated example is hardware. For example, the processor 1312 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements communications interface 1002, the example auditing instruction generator 1004, the example product dimensional analyzer 1006, the example product variance analyzer 1008, the example sample size determiner 1010, the example customer error margin analyzer 1012, the example sampling frequency determiner 1014, the example geographic area determiner 1016, the example factory accuracy comparator 1018, the example report generator 1020, and the example pool of stores generator 1022.

The processor 1312 of the illustrated example includes a local memory 1313 (e.g., a cache). The processor 1312 of the illustrated example is in communication with a main memory including a volatile memory 1314 and a non-volatile memory 1316 via a bus 1318. The volatile memory 1314 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 1316 may be implemented by flash memory and/or any other desired type of memory device. Access to the main memory 1314, 1316 is controlled by a memory controller.

The processor platform 1300 of the illustrated example also includes an interface circuit 1320. The interface circuit 1320 may be implemented by any type of interface standard, such as an Ethernet interface, a universal serial bus (USB), a Bluetooth® interface, a near field communication (NFC) interface, and/or a PCI express interface.

In the illustrated example, one or more input devices 1322 are connected to the interface circuit 1320. The input device(s) 1322 permit(s) a user to enter data and/or commands into the processor 1312. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 1324 are also connected to the interface circuit 1320 of the illustrated example. The output devices 1324 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 1320 of the illustrated example, thus, typically includes a graphics driver card, a graphics driver chip and/or a graphics driver processor.

The interface circuit 1320 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 1326. The communication can be via, for example, an Ethernet connection, a digital subscriber line (DSL) connection, a telephone line connection, a coaxial cable system, a satellite system, a line-of-site wireless system, a cellular telephone system, etc.

The processor platform 1300 of the illustrated example also includes one or more mass storage devices 1328 for storing software and/or data. Examples of such mass storage devices 1328 include floppy disk drives, hard drive disks, compact disk drives, Blu-ray disk drives, redundant array of independent disks (RAID) systems, and digital versatile disk (DVD) drives.

The example store information database 1024, and/or the example product information database 1026 may be stored in the example mass storage 1328.

The machine executable instructions 1332 of FIGS. 11-12 may be stored in the mass storage device 1328, in the volatile memory 1314, in the non-volatile memory 1316, and/or on a removable non-transitory computer readable storage medium such as a CD or DVD.

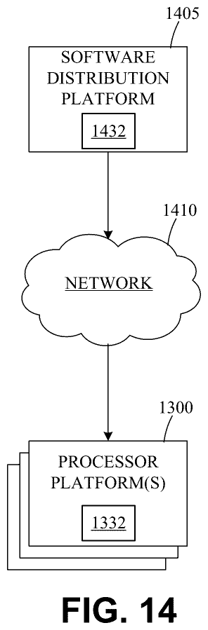

A block diagram illustrating an example software distribution platform 1405 to distribute software such as the example computer readable instructions 1332 of FIG. 13 to third parties is illustrated in FIG. 14. The example software distribution platform 1405 may be implemented by any computer server, data facility, cloud service, etc., capable of storing and transmitting software to other computing devices. The third parties may be customers of the entity owning and/or operating the software distribution platform. For example, the entity that owns and/or operates the software distribution platform may be a developer, a seller, and/or a licensor of software such as the example computer readable instructions 1332 of FIG. 13. The third parties may be consumers, users, retailers, OEMs, etc., who purchase and/or license the software for use and/or re-sale and/or sub-licensing. In the illustrated example, the software distribution platform 1405 includes one or more servers and one or more storage devices. The storage devices store the computer readable instructions 1332, which may correspond to the example computer readable instructions 1100 and 1200 of FIGS. 11-12, as described above. The one or more servers of the example software distribution platform 1405 are in communication with a network 1410, which may correspond to any one or more of the Internet and/or any of the example networks 1326 described above. In some examples, the one or more servers are responsive to requests to transmit the software to a requesting party as part of a commercial transaction. Payment for the delivery, sale and/or license of the software may be handled by the one or more servers of the software distribution platform and/or via a third party payment entity. The servers enable purchasers and/or licensors to download the computer readable instructions 1432 from the software distribution platform 1405. For example, the software, which may correspond to the example computer readable instructions 1332 of FIG. 13, may be downloaded to the example processor platform 1300, which is to execute the computer readable instructions 1332 to implement the sample frequency determiner 618. In some example, one or more servers of the software distribution platform 1405 periodically offer, transmit, and/or force updates to the software (e.g., the example computer readable instructions 1332 of FIG. 13) to ensure improvements, patches, updates, etc. are distributed and applied to the software at the end user devices.

From the foregoing, it will be appreciated that example methods, apparatus and articles of manufacture have been disclosed that adaptively collect market research data. The disclosed methods, apparatus and articles of manufacture improve the efficiency of using a computing device by reducing wasted data collection time, saving processors from storing inaccurate data, and improving accuracy of a sampling event. The disclosed methods, apparatus and articles of manufacture are accordingly directed to one or more improvement(s) in the functioning of a computer.

Disclosed herein are example systems, apparatus and methods for adaptive data collection. Further examples and combinations thereof include the following:

Example 1 includes an apparatus to control auditing devices, comprising a communications interface to transmit first auditing instructions to the auditing devices, a sampling frequency determiner to collect sampling information corresponding to a first number of stores at a first time, a sample size determiner to calculate a second number of stores to sample based on the sampling information, and when a difference between the first number of stores and the second number of stores satisfies a threshold, improve an accuracy in the sampling information by calculating second auditing instructions having an updated sampling frequency.

Example 2 includes the apparatus as defined in example 1, wherein the sampling information includes product information sold by the first number of stores and product information sold by the second number of stores.

Example 3 includes the apparatus as define in example 2, wherein the product variance analyzer is to calculate the difference between the product information sold by the first number of stores and the product information sold by the second number of stores as product variance data.

Example 4 includes the apparatus as defined in example 1, wherein the product dimensional analyzer is to sample products, the products including dimension data as at least one of product price, sales volume, packing configuration, display, promotion, category, store, geographic location and manufacturer.

Example 5 includes the apparatus as defined in example 1, wherein the product dimensional analyzer is to sample panelists, the panelists associated with dimension data having at least one of age, geography, ethnicity, income levels, education, and gender.

Example 6 includes the apparatus as defined in example 1, wherein the first number of stores is dynamically updated based on the sampling information and product variance data.

Example 7 includes the apparatus as defined in example 1, further including a geographic area determiner to update the first auditing instructions associated with first nodes operable in a first geographic location, the first nodes corresponding to first ones of the auditing devices.

Example 8 includes the apparatus as defined in example 7, wherein the first auditing instructions corresponding to second nodes in a second geographic location are unchanged.

Example 9 includes the apparatus as defined in example 1, further including an auditing instruction generator, wherein the first auditing instructions include a first number of stores to visit in a first geographic region, and in response to receiving updated auditing instructions, the auditing instruction generator is to cause auditing of visiting a second number of stores in a second geographic region, and to cause auditing of a third number of stores in a third geographic region, wherein the second number of stores and the third number of stores is less than a remainder of the first number of stores.

Example 10 includes the apparatus as defined in example 9, wherein the updated auditing instructions are updated in response to receiving out of stock information for a first product for a first number of stores from at least one of the at least two geographic regions.

Example 11 includes a non-transitory computer readable storage medium comprising computer readable instructions, that, when executed, cause one or more processors to, at least transmit first auditing instructions to auditing devices, collect sampling information corresponding to a first number of stores at a first time, calculate a second number of stores to sample based on the sampling information, and when a difference between the first number of stores and the second number of stores satisfies a threshold, improve an accuracy in the sampling information by calculating second auditing instructions having an updated sampling frequency.

Example 12 includes the non-transitory computer readable storage medium as defined in example 11, wherein the sampling information includes product information sold by the first number of stores and product information sold by the second number of stores.

Example 13 includes the non-transitory computer readable storage medium as defined in example 12, wherein the computer readable instructions, when executed, further cause the one or more processors to calculate the difference between the product information sold by the first number of stores and the product information sold by the second number of stores as product variance data.

Example 14 includes the non-transitory computer readable storage medium as defined in example 11, wherein the computer readable instructions, when executed, further cause the one or more processors to sample products, the products including dimension data as at least one of product price, sales volume, packing configuration, display, promotion, category, store, geographic location and manufacturer.

Example 15 includes the non-transitory computer readable storage medium as defined in example 11, wherein the computer readable instructions, when executed, further cause the one or more processors to sample panelists, the panelists associated with dimension data having at least one of age, geography, ethnicity, income levels, education, and gender.

Example 16 includes the non-transitory computer readable storage medium as defined in example 11, wherein the first number of stores is dynamically updated based on the sampling information and product variance data.

Example 17 includes the non-transitory computer readable storage medium as defined in example 11, wherein the computer readable instructions, when executed, further cause the one or more processors to update the first auditing instructions associated with first nodes operable in a first geographic location, the first nodes corresponding to first ones of the auditing devices.

Example 18 includes the non-transitory computer readable storage medium as defined in example 17, wherein the first auditing instructions corresponding to second nodes in a second geographic location are unchanged.

Example 19 includes the non-transitory computer readable storage medium as defined in example 11, wherein the first auditing instructions include a first number of stores to visit in a first geographic region, and in response to receiving updated auditing instructions, wherein the computer readable instructions, when executed, further cause the one or more processors to cause auditing of visiting a second number of stores in a second geographic region, and to cause auditing of a third number of stores in a third geographic region, wherein the second number of stores and the third number of stores is less than a remainder of the first number of stores.

Example 20 includes the non-transitory computer readable storage medium as defined in example 19, wherein the updated auditing instructions are updated in response to receiving out of stock information for a first product for a first number of stores from at least one of the at least two geographic regions.

Example 21 includes an apparatus comprising memory, and processor circuitry configured to at least transmit first audit instructions to auditing devices, collect sampling information corresponding to a first number of stores at a first time, calculate a second number of stores to sample based on the sampling information, and when a difference between the first number of stores and the second number of stores satisfies a threshold, improve an accuracy in the sampling information by calculating second auditing instructions having an updated sampling frequency.

Example 22 includes the apparatus as defined in example 21, wherein the sampling information includes product information sold by the first number of stores and product information sold by the second number of stores.

Example 23 includes the apparatus as defined in example 22, wherein the processor circuitry is further to calculate the difference between the product information sold by the first number of stores and the product information sold by the second number of stores as product variance data.

Example 24 includes the apparatus as defined in example 21, wherein the processor circuitry is further to sample products, the products including dimension data as at least one of product price, sales volume, packing configuration, display, promotion, category, store, geographic location and manufacturer.

Example 25 includes the apparatus as defined in example 21, wherein the processor circuitry is further to sample panelists, the panelists associated with dimension data having at least one of age, geography, ethnicity, income levels, education, and gender.

Example 26 includes the apparatus as defined in example 21, wherein the first number of stores is dynamically updated based on the sampling information and product variance data.

Example 27 includes the apparatus as defined in example 21, wherein the processor circuitry is further to update the first auditing instructions associated with first nodes operable in a first geographic location, the first nodes corresponding to first ones of the auditing devices.

Example 28 includes the apparatus as defined in example 27, wherein the first auditing instructions corresponding to second nodes in a second geographic location are unchanged.

Example 29 includes the apparatus as defined in example 21, wherein the first auditing instructions include a first number of stores to visit in a first geographic region, and in response to receiving updated auditing instructions, wherein the processor circuitry is further to cause auditing of visiting a second number of stores in a second geographic region, and to cause auditing of a third number of stores in a third geographic region, wherein the second number of stores and the third number of stores is less than a remainder of the first number of stores.

Example 30 includes the apparatus as defined in example 29, wherein the updated auditing instructions are updated in response to receiving out of stock information for a first product for a first number of stores from at least one of the at least two geographic regions.

Example 31 includes an edge network, comprising at least two nodes and a central office, wherein the edge network is to improve computer efficiency and reduce wasted cycles and improve accurate data collection by using the central office to determine a universe of stores and distribution parameters of their dimensions in a relevant market, determine a pool of stores within the universe of stores from which market research data may be collected, and identify sample of stores from the pool of stores, and transmit instructions to collect market research data from sample of stores to the at least two nodes, using at least one of the at least two nodes to collect market research data, transmit market research data to the central office, the central office to in response to the market research data collected by the one of two nodes, determine to update the universe of stores in the relevant market in the instructions, and transmit the updated instructions to collect market research data from sample of stores to at least one of the at least two nodes.

Example 32 includes the edge network of example 31, wherein a first node collects market research data and in response to the market research data, updated instructions are transmitted by the central office to a second node.

It is noted that this patent claims priority from Indian Patent Application Serial Number 202011024786, which was filed on Jun. 12, 2020, and is hereby incorporated by reference in its entirety.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

The following claims are hereby incorporated into this Detailed Description by this reference, with each claim standing on its own as a separate embodiment of the present disclosure.

1.-32. (canceled)

33. An apparatus comprising:
interface circuitry;
machine-readable instructions; and
at least one processor circuit to be programmed by the machine-readable instructions to:
set a first sample size audit instruction based on a first quantity of data sources at a first time;
cause transmission of the first sample size audit instruction to node devices via a network, the node devices to execute the first sample size audit instruction to capture data corresponding to a first sample size;
determine a second quantity of the data sources at a second time after the first time;
determine a difference between the first quantity and the second quantity satisfies a threshold;
determine a second sample size audit instruction based on the second quantity; and
cause transmission of the second sample size audit instruction to the node devices via the network, the node devices to execute the second sample size audit instruction to cause the node devices to capture data corresponding to a second sample size.

34. The apparatus as defined in claim 33, wherein one or more of the at least one processor circuit is to cause transmission of the first sample size audit instruction to first ones of the node devices associated with a first geographic location and cause transmission of the second sample size audit instruction to second ones of the node devices associated with a second geographic location.

35. The apparatus as defined in claim 33, wherein one or more of the at least one processor circuit is to determine the second sample size audit instruction based on the difference and a target error value.

36. The apparatus as defined in claim 33, wherein the node devices include a robotic data collector, one or more of the at least one processor circuit is to deploy the robotic data collector to acquire the data at the second sample size.

37. At least one non-transitory machine-readable medium comprising machine-readable instructions to cause at least one processor circuit to at least:
set a first sample size audit instruction based on a first quantity of data sources at a first time;
cause transmission of the first sample size audit instruction to node devices via a network, the node devices to execute the first sample size audit instruction to capture data corresponding to a first sample size;
determine a second quantity of the data sources at a second time after the first time;
determine a difference between the first quantity and the second quantity satisfies a threshold;
determine a second sample size audit instruction based on the second quantity; and
cause transmission of the second sample size audit instruction to the node devices via the network, the node devices to execute the second sample size audit instruction to cause the node devices to capture data corresponding to a second sample size.

38. The at least one non-transitory machine-readable medium of claim 37, wherein the machine-readable instructions are to cause one or more of the at least one processor circuit to cause transmission of the first sample size audit instruction to first ones of the node devices associated with a first geographic location and cause transmission of the second sample size audit instruction to second ones of the node devices associated with a second geographic location.

39. The at least one non-transitory machine-readable medium of claim 37, wherein the machine-readable instructions are to cause one or more of the at least one processor circuit to deploy the node devices as robotic data collectors, the robotic data collectors to acquire the data at the second sample size.
